(19) United States
(12) Patent Application Publication
(10) Pub. No.: US 2005/0186854 A1
(43) Pub. Date: Aug. 25, 2005

(54) Signal cable adapter

(76) Inventor: Chien-Pin Huang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/781,890

(22) Filed: Feb. 20, 2004

(51) Int. Cl. H01R 12/00

(52) U.S. Cl. 439/677

(57) ABSTRACT

The invention relates to a signal cable adapter utilizing six-pin IEEE 1394 with better transmission capacity and more connecting pins to be the primary fitting of the adapter of the invention. Meanwhile the models of RJ11, RJ45, USB (including USB A, USB B, 4-pin Mini-USB, 5-pin Mini-USB) with less connecting pins and normal transmission capacity serve as the secondary fitting of the adapter of the invention. Therefore, the adapter of the invention can join two signal transmission connectors having different sizes, designs, etc., enabling them to be fitted or to work together for data transmission between different connectors.

### BACKGROUND OF THE INVENTION

1. Field of the Invention

The invention relates to a signal cable adapter, and more particularly, to a device for joining a signal cable plug of a certain model to another signal cable plug of different models, enabling them to be fitted or to work together for data transmission between different connectors.

2. Description of the Related Art

With the popularization of the personal computer and the development of communication industry, many peripherals together with their signal cables, male fittings and female fittings have been developed. However, their compatibility is lowered due to their diversification in size, format, function and design, etc.

At present, the common transmission cables are divided into four types. They are telephone cable with RJ11 plug, network cable with RJ45 plug, universal serial bus (USB) cables (including USB A, USB B, 4-pin Mini-USB, 5-pin Mini-USB) and four- and six-pin IEEE 1394. The telephone cable with RJ11 plug is used for connection to a modem in surfing the Internet. The network cable with RJ45 plug is used for connection of a network interface card to a local area network (LAN). USB-cable is used to connect digital cameras, printers, scanners, personal digital assistants (PDA) or other peripherals to personal computer for data transmission. The cable with the IEEE 1394 plug is used for the transmission of mobile image data of digital video camera. Since the above-mentioned cables differ in the number of wire, the connector's size and the position of terminal contact, they are incompatible to one another. Meanwhile, a number of the transmission cables occupy much space, cause trouble in storage and result in cost increase. In addition, it's inconvenient to carry many transmission cables in using notebook computer during business trip.

### SUMMARY OF THE INVENTION

In light of the demerits of the prior art, the invention provides a signal cable adapter that aims to ameliorate at least some of the disadvantages of the prior art or to provide a useful alternative.

A primary objective of the invention is to provide a signal cable adapter utilizing six-pin IEEE 1394 with better transmission capacity and more connecting pins to be the primary fitting of the adapter of the invention. Meanwhile the models of RJ11, RJ45, USB (including USB A, USB B, 4-pin Mini-USB, 5-pin Mini-USB) with less connecting pins and normal transmission capacity serve as the secondary fitting of the adapter of the invention. Therefore, the adapter of the invention can join two signal transmission connectors having different sizes, designs, etc., enabling them to be fitted or to work together for data transmission between different connectors.

### BRIEF DESCRIPTION OF THE DRAWINGS

The accomplishment of this and other objects of the invention will become apparent from the following description and its accompanying drawings of which:

FIG. 1 is a perspective view of a first embodiment of the invention;

FIG. 1A is a perspective view from the other side of the first embodiment of the invention;

FIG. 2 is a perspective view of a second embodiment of the invention;

FIG. 3 is a perspective view of a third embodiment of the invention;

FIG. 4 is a perspective view of a fourth embodiment of the invention;

FIG. 5 is a perspective view of a fifth embodiment of the invention; and

FIG. 6 is a perspective view of a sixth embodiment of the invention.

### DETAILED DESCRIPTION OF THE PREFERRED EMBODIMENT

Among the signal transmission cables for peripherals, six-pin IEEE 1394 has better transmission capacity and more connecting pins. Therefore, six-pin IEEE 1394 is used to be the primary fitting of the adapter of the invention. Meanwhile, the models of RJ11, RJ45, USB (including USB A, USB B, 4-pin Mini-USB, 5-pin Mini-USB) with less connecting pins and normal transmission capacity are used to be the secondary fitting of the adapter of the invention. Therefore, the adapter of the invention can join two signal transmission connectors having different sizes, designs, etc., enabling them to be fitted or to work together for data transmission between different connectors.

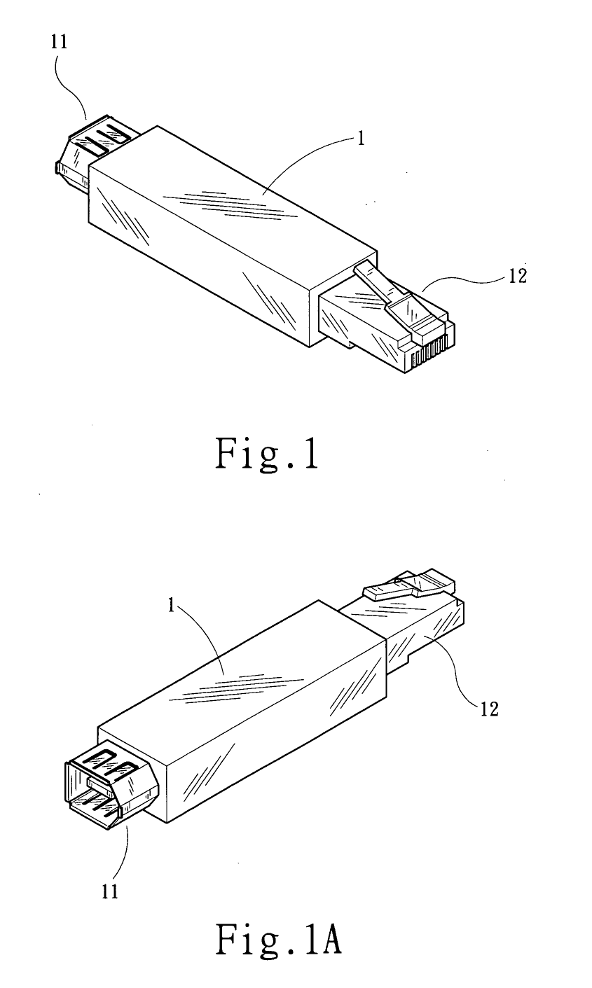

FIG. 1 shows a first embodiment of the invention. It's apparent from FIG. 1 together with FIG. 1A that the adapter 1 of the invention includes a primary fitting 11 and a secondary fitting 12. The primary fitting 11 is constructed as female contact with the model of six-pin IEEE 1394 while the secondary fitting 12 is constructed as male plug with the model of RJ45.

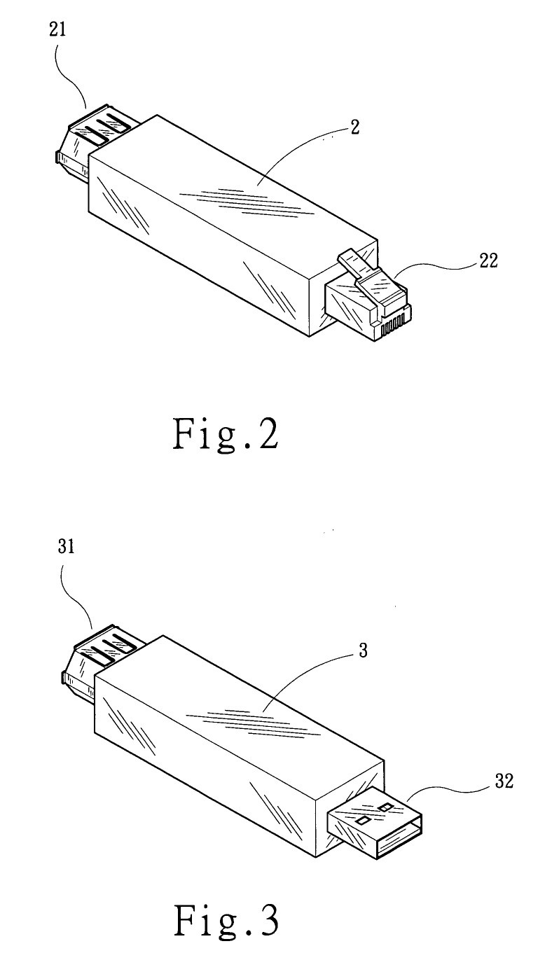

FIG. 2 shows a second embodiment of the invention. It's apparent from FIG. 2 that the adapter 1 of the second embodiment of the invention includes a primary fitting 21 and a secondary fitting 22. The primary fitting 21 is constructed as female contact with the model of six-pin IEEE 1394 while the secondary fitting 22 is constructed as male plug with the model of RJ11.

FIG. 3 shows a third embodiment of the invention. It's apparent from FIG. 3 that the adapter 1 of the third embodiment of the invention includes a primary fitting 31 and a secondary fitting 32. The primary fitting 31 is constructed as female contact with the model of six-pin IEEE 1394 while the secondary fitting 32 is constructed as male plug with the model of USB A.

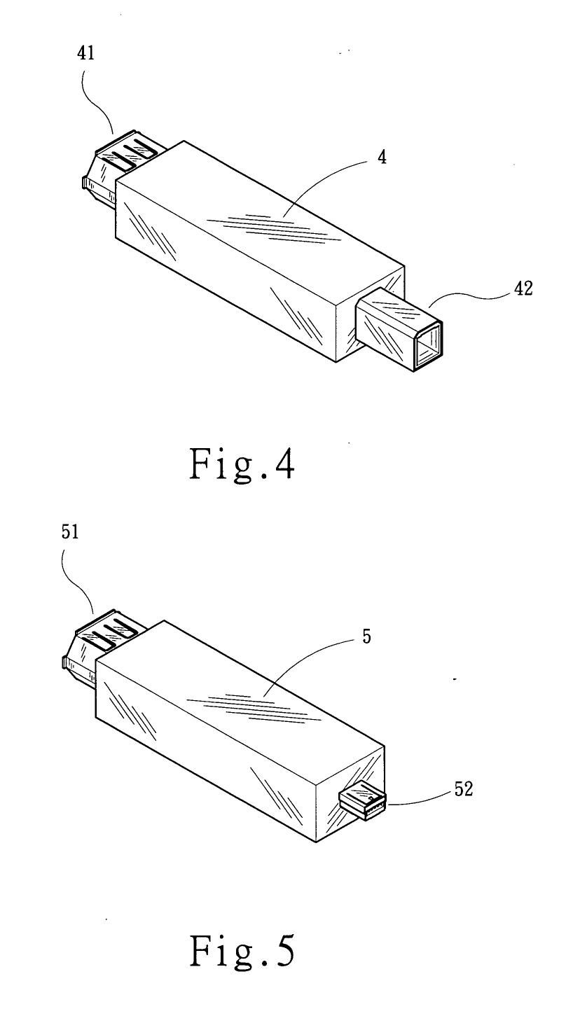

FIG. 4 shows a fourth embodiment of the invention. It's apparent from FIG. 4 that the adapter 1 of the third embodiment of the invention includes a primary fitting 41 and a secondary fitting 42. The primary fitting 41 is constructed as female contact with the model of six-pin IEEE 1394 while the secondary fitting 42 is constructed as male plug with the model of USB B.

FIG. 5 shows a fifth embodiment of the invention. It's apparent from FIG. 5 that the adapter 1 of the third embodiment of the invention includes a primary fitting 51 and a secondary fitting 52. The primary fitting 51 is constructed as female contact with the model of six-pin IEEE 1394 while the secondary fitting 52 is constructed as male plug with the model of 4-pin Mini-USB.

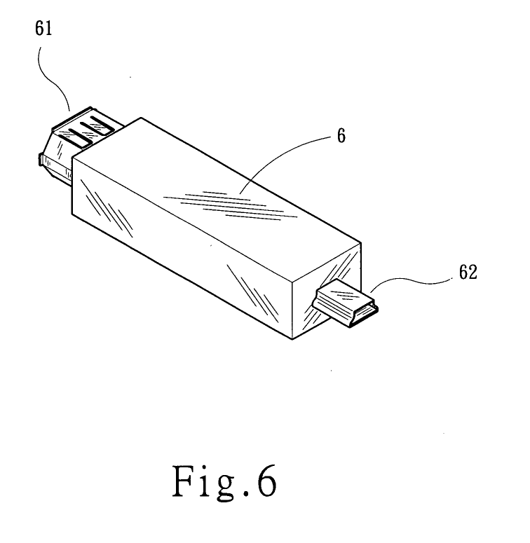

FIG. 6 shows a fifth embodiment of the invention. It's apparent from FIG. 6 that the adapter 1 of the third embodiment of the invention includes a primary fitting 61 and a secondary fitting 62. The primary fitting 61 is constructed as female contact with the model of six-pin IEEE 1394 while the secondary fitting 62 is constructed as male plug with the model of 5-pin Mini-USB.

In the above-mentioned embodiments, the primary fitting 61 is constructed as female contact with the model of six-pin IEEE 1394 while the secondary fitting is constructed as male plug having different models. Alternatively, the primary fitting 61 is constructed as male plug with the model of six-pin IEEE 1394 while the secondary fitting is also constructed as male plug having different models. This alternative construction can achieve the same effect.

For the actual application, the adapter of the invention is used with a common signal transmission cable having 6-pin IEEE 1394 connectors at its both ends in the form of male or female contact. Therefore, the primary fitting of the invention (6-pin IEEE 1394) is joined to the 6-pin IEEE 1394 connector of the common signal transmission cable while the secondary fitting of the invention in different models is joined to different connectors, thereby achieving the signal transmission effect between different connectors.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1. A signal cable adapter comprising a primary fitting and a secondary fitting at both ends of the adapter,
wherein the primary and secondary fitting are constructed in different sizes and designs, and wherein either of the primary and secondary fitting acts as signal input for establishing an electrical connection with the signal source while the other one serves as signal output such that the adapter can join two signal transmission connectors having different sizes, designs, etc., enabling them to be fitted or to work together for data transmission between different connectors.

2. The signal cable adapter of claim 1 wherein the secondary fitting contains less connecting pins than the primary fitting.

3. The signal cable adapter of claim 1 wherein the primary fitting is constructed as connector with the model of six-pin IEEE 1394.

4. The signal cable adapter of claim 2 wherein the primary fitting is constructed as connector with the model of six-pin IEEE 1394.

5. The signal cable adapter of claim 3 wherein the primary fitting is constructed as male plug with the model of six-pin IEEE 1394.

6. The signal cable adapter of claim 4 wherein the primary fitting is constructed as male plug with the model of six-pin IEEE 1394.

7. The signal cable adapter of claim 3 wherein the primary fitting is constructed as female contact with the model of IEEE 1394.

8. The signal cable adapter of claim 4 wherein the primary fitting is constructed as female contact with the model of IEEE 1394.

9. The signal cable adapter of claim 3 wherein the secondary fitting is constructed as connector with the model of RJ11.

10. The signal cable adapter of claim 4 wherein the primary fitting is constructed as connector with the model of RJ11.

11. The signal cable adapter of claim 3 wherein the secondary fitting is constructed as connector with the model of RJ45.

12. The signal cable adapter of claim 4 wherein the primary fitting is constructed as connector with the model of RJ45.

13. The signal cable adapter of claim 3 wherein the secondary fitting is constructed as connector with the model of universal serial bus (USB).

14. The signal cable adapter of claim 4 wherein the secondary fitting is constructed as connector with the model of universal serial bus (USB).
